(19) United States
(12) Patent Application Publication
(10) Pub. No.: US 2022/0205071 A1
(43) Pub. Date: Jun. 30, 2022

(54) FE-BASED AMORPHOUS ALLOY CONTAINING SUBNANOMETER-SCALE ORDERED CLUSTERS, AND PREPARATION METHOD AND NANOCRYSTALLINE ALLOY DERIVATIVE THEREOF

(71) Applicant: Ningbo Zhongke B Plus New Materials Technology Co., LTD, Ningbo (CN)

(72) Inventors: He MEN, Ningbo (CN); Hai GUO, Ningbo (CN); Lishan HUO, Ningbo (CN)

(21) Appl. No.: 17/655,550

(22) Filed: Mar. 19, 2022

Related U.S. Application Data
(63) Continuation of application No. PCT/CN2019/109427, filed on Sep. 30, 2019.

(30) Foreign Application Priority Data
Sep. 23, 2019 (CN) 201910897387.8

(51) Int. Cl. C22C 45/02; C22C 33/00; H01F 1/153

(52) U.S. Cl. CPC C22C 45/02; H01F 1/15341; H01F 1/15333; C22C 33/003

(57) ABSTRACT

A Fe-based amorphous alloy containing subnanometer-scale ordered clusters, and a preparation method and a nanocrystalline alloy derivative thereof. The composition expression of the Fe-based amorphous alloy is FeₐSi_{b}B_{c}(Cu_{d}Xₑ)M_{f}M′_{g}, and X is at least one of Ti, Zr and Hf, M is at least one of V, Ta and Nb, and M′ at least one of Co, Ni, C, P, Ge, Cr, Mn, W, Zn, Sn, Sb and Mo; a, b, c, d, e, f and g respectively represent the atomic percent (percentage of the number of atoms) of the corresponding element, and satisfy: 74≤a≤82, 8≤b≤15, 4≤c≤10, 0.5≤d≤1.2, 0.4≤e≤1.8, 1≤f≤3.5, 0≤g≤1, 0.8≤e/d≤1.5 and a+b+c+d+e+f+g=100; the Fe-based amorphous alloy is a composite material composed of an amorphous alloy matrix with atoms arranged in complete disorder and ordered atomic clusters having the size ranging from 0.5 nm to 2 nm uniformly dispersed and distributed in the matrix. The Fe-based amorphous alloy has ultrahigh permeability: the permeability at the frequency of 100 kHz is more than 35000, and the saturation flux density more than 1.3 T.

### CROSS-REFERENCE TO RELATED APPLICATION(S)

This application is a continuation of co-pending International Patent Application No. PCT/CN2019/109427, filed on Sep. 30, 2019, which claims the priority and benefit of Chinese patent application number 201910897387.8, filed Sep. 23, 2019 with China National Intellectual Property Administration, the entire contents of which are incorporated herein by reference.

### TECHNICAL FIELD

The invention relates to a soft magnetic material in the field of magnetic functional materials, in particular to a Fe-based amorphous alloy containing subnanometer-scale ordered clusters, and a preparation method and a nanocrystalline alloy derivative thereof.

### BACKGROUND

Compared with traditional soft magnetic materials (such as ferrite, silicon steel and the like), amorphous-nanocrystalline soft magnetic alloys are a new type of soft magnetic materials having excellent soft magnetic properties (lower coercivity, higher permeability, etc.) and higher saturation flux density Bs. Power electronic components, such as transformers, motors, instrument transformers, filter inductors, inverters and wireless charging modules, that are made of amorphous-nanocrystalline alloys as core materials have the advantages of smaller size, higher efficiency, higher precision, higher quality and the like as compared with similar components made of traditional soft magnetic materials. Thus, they have been widely used in the fields of automobiles, variable frequency electrical appliances, power systems, new energy power generation, communication and electronic equipment, wireless charging and the like, and have played an important role in the development of various power electronic devices toward miniaturization, energy saving and high precision in daily life and industrial production.

With the rapid development of technology and economy, the demand for power electronic components in various fields is constantly increasing. In addition to the continuous development toward miniaturization, energy saving and high precision, the operating frequency of the power electronic components is also rapidly increasing. For example, in the emerging field of wireless charging in recent years, Qi Wireless Charging Standard based on the principle of electromagnetic induction has been widely used in smart phones, Bluetooth headsets, smart watches and other consumer electronic products, and its electromagnetic wave frequency of wireless power transmission is 100-205 kHz, that is, the working frequency of soft magnetic materials therein is 100-205 kHz. The PMA Standard, which is also based on the principle of electromagnetic induction, has an electromagnetic wave frequency of up to 277-357 kHz and a transmission power greater than that of the Qi Standard, and thus, has wide application prospects in future. In high-end applications in the field of high-frequency filter inductors, such as common-mode inductors for high-end automobiles, the working frequency has now reached 100 kHz or above, and there is a trend and demand for rapid development toward higher frequency band. With the popularization and application of 5G technology, the development of electronic components toward higher frequency band is an inevitable trend.

The development of power electronic components toward miniaturization, energy saving, high frequency and high precision requires the soft magnetic materials therein to have higher saturation flux density Bs, higher high-frequency permeability μ, lower coercivity Hc and lower loss value. Among the commonly used soft magnetic materials, silicon steel has the highest saturation flux density (2.0 T or above), but has higher coercivity Hc and loss and lower permeability, and thus, is only suitable for low-frequency applications (1 kHz or below), such as distribution transformers, conventional motors, etc. Ferrite has higher high-frequency permeability, but its saturation flux density is too low, generally less than 0.5 T, which hinders the development of devices toward miniaturization and high power. Commercial amorphous soft magnetic alloy ribbons have higher saturation flux density (−1.56 T), but have lower high-frequency permeability and higher high-frequency loss, and thus, are mainly used in the applications of 10 kHz or below. Commercial FINEMET series of nanocrystalline soft magnetic alloy ribbons, which are currently soft magnetic materials having obvious advantages at the frequency band of 10 kHz or above, have saturation flux density of −1.25 T, higher high-frequency permeability and lower high-frequency loss. However, with the development of the power electronic components toward further miniaturization, high power and high frequency, the disadvantages of the commercial FINEMET series of nanocrystalline alloy ribbons have gradually emerged: (1) the saturation flux density is lower, which is not conducive to the further miniaturization or high power of devices; and (2) the permeability at the frequency band of 100 kHz or above is not high enough, which hinders the development toward further high frequency of components.

In the prior art, using vacuum transverse magnetic field heat treatment and ribbon thinning, the high-frequency permeability of the FINEMET series of nanocrystalline alloy ribbons can be increased to some extent. However, since the basic alloy composition and the microstructure of the material are not improved, the use of vacuum magnetic field heat treatment and ribbon thinning has limited effects on improving high-frequency permeability: using the combination of transverse magnetic field heat treatment and ribbon thinning, the effective permeability, at 10 kHz, of a nanocrystalline ribbon with a thickness of 16 μm can be generally increased to 60000 or above, and the effective permeability at 100 kHz can be increased to 30000. However, based on the existing ribbon preparation technique, 16 μm is already the lowest thickness limit of mass-produced ribbons, and the yield is very low, which seriously hinders the development of electronic components toward high frequency and miniaturization.

However, at present, there are many studies on novel nanocrystalline alloys with higher permeability at the frequency band of 10 kHz or below, but few studies on novel nanocrystalline alloys with higher permeability, lower loss and higher saturation flux density at the frequency band of 100 kHz or above.

The invention patent CN 101796207B of Hitachi Metals Ltd. in Japan discloses an Fe—M—Si—B—Cu nanocrystalline alloy. The permeability at 1 kHz of this series of nanocrystalline alloy ribbons reaches 129000 or above, but the permeability at 100 kHz is less than 20000.

Chinese patent CN 108559926A discloses a Fe—Si—B—Nb—V—Cu—Co nanocrystalline alloy with high permeability at high frequency. The effective permeability at the frequency of 10 kHz of this series of nanocrystalline alloy ribbons can reach 80000 or above without vacuum transverse magnetic field annealing, and the effective permeability at the frequency of 100 kHz can reach 30000. However, the Fe content of nanocrystalline alloys of this series is low, and the atomic percent is only 67%-74.2%. Although the value of saturation flux density is not given in the specification of the patent, according to the technical experience in the field of nanocrystalline alloys that the saturation flux density is positively correlated with the Fe content, most ingredients in the alloys of this series have a saturation flux density lower than that of a commercial FINEMET alloy (with a Fe content of about 73.5 at %), that is, lower than 1.25 T, which is not conductive to miniaturization of electronic components.

Thus, there is a serious lack of novel soft magnetic materials having higher permeability, lower loss and higher saturation flux density at high frequency, especially at the frequency band of 100 kHz or above, which are currently required by power electronic components, thereby hindering the development of the power electronic components toward high frequency and miniaturization.

### SUMMARY

In view of the problems in the prior art, through an innovative amorphous alloy ingredient and microstructure design scheme, the invention provides a Fe-based amorphous alloy containing subnanometer-scale ordered clusters and a preparation method thereof. After the amorphous alloy is heat-treated, the formed nanocrystalline alloy has an effective permeability of 35000 or above and a saturation flux density of 1.3 T or above at the frequency of 100 kHz. Besides, wide ribbons can be prepared from industrial raw materials using industrialized ribbon making equipment, thereby meeting the demand of power electronic components for novel soft magnetic materials having higher high-frequency permeability, lower loss and higher saturation flux density at present.

In order to solve the technical problems above, the invention adopts the following technical solutions:

(I) Alloy Ingredient and Microstructure Design

The invention provides a Fe-based amorphous alloy containing subnanometer-scale ordered clusters. The composition expression of the Fe-based amorphous alloy is FeₐSi_{b}B_{c}(Cu_{d}Xₑ)M_{f}M′_{g}, where X is at least one of Ti, Zr and Hf, M is at least one of V, Ta and Nb, and M′ is at least one of Co, Ni, C, P, Ge, Cr, Mn, W, Zn, Sn, Sb and Mo; where a, b, c, d, e, f and g respectively represent the atomic percent (percentage of the number of atoms) of the corresponding element, and satisfy: 74≤a≤82, 8≤b≤15, 4≤c≤10, 0.5≤d≤1.2, 0.4≤e≤1.8, 1≤f≤3.5, 0≤g≤1, 0.8≤e/d≤1.5 and a+b+c+d+e+f+g=100. The Fe-based amorphous alloy is a composite composed of an amorphous alloy matrix with atoms arranged completely disorderly and ordered atom clusters with a size of 0.5-2 nm homogeneously dispersed in the matrix.

Further, the above ordered atom clusters in the above Fe-based amorphous alloy in the invention are Cu—X body-centered cubic clusters formed by Cu atoms and X atoms.

Further, the above Fe-based amorphous alloy of the invention may be ribbon-like, powder-like or wire-like in shape.

The above design of the Fe-based amorphous alloy containing subnanometer-scale ordered clusters in the invention is realized through the following ideas:

According to the magnetic theory of soft magnetic materials, the permeability μ of the nanocrystalline alloy is ∝1/D⁶, where D is the grain diameter. As can be seen, reducing the average grain diameter of the alloy is an important means to improve the permeability. At present, the commercial FINEMET nanocrystalline alloy has an internal grain size of about 10-20 nm. Therefore, the key of the invention is to design a solution for preparing a nanocrystalline alloy with smaller grain size.

A nanocrystalline soft magnetic alloy is generally prepared by heat-treating an amorphous alloy, which precipitates α-Fe grains with diameters ranging from ten to tens of nanometers. The amorphous alloy is a homogeneous disordered system, and there are no heterogeneous nucleation sites for grain precipitation. Therefore, it is very difficult to prepare a nanocrystalline alloy with homogeneous grain size distribution by crystallization of amorphous alloy. Moreover, the smaller the grain size of the alloy, the more difficult it is to prepare. As shown by massive research and development work on novel high-performance nanocrystalline alloys, the novel nanocrystalline alloys are prone to problems such as heterogeneous structure and formation of coarse α-Fe grains in the preparation and heat treatment process, leading to the degradation of soft magnetic properties and the increase of loss.

The inventors provide a method for reducing the size of subsequent precipitated grains by increasing the heterogeneity of the amorphous alloy: subnanometer-scale ordered atom clusters are introduced into the amorphous alloy such that the amorphous alloy is prepared into a composite composed of an amorphous alloy matrix with atoms arranged completely disorderly and subnanometer-scale ordered atom clusters homogeneously dispersed in the matrix. In the subsequent heat treatment process of the amorphous alloy, these homogeneously distributed ordered atom clusters provide nucleation sites for the precipitation of α-Fe crystals from the amorphous alloy matrix, and can prevent the formed α-Fe grains from further growth and prevent formation of the coarse grains.

The enthalpy of mixing between Cu and Fe, B, V, Cr, Mn, Co, Ni, Zn, Ga, Nb, Mo, Sn, Sb, Ta, W and other elements in a binary mixture is positive or 0. That is, when the Cu atoms are mixed with the atoms of the aforementioned various elements, the Cu atoms have a weak bonding force with these elements, and cannot easily form atom pairs having a strong bonding force with the atoms of these elements. However, the inventors find that the enthalpy of mixing between Cu and Ti, Zr and Hf (collectively referred to as X in the invention) is negative, and Cu—X atom pairs with a strong bonding force can be formed. Moreover, by carefully adjusting the contents of Cu and X and the ratio of Cu to X in the Fe-based amorphous alloy and using an appropriate preparation method of the amorphous alloy, Cu—X body-centered cubic clusters with a size of 0.5-2 nm can be formed in Fe-based amorphous alloy.

It should be noted that the lattice structure of the Cu—X body-centered cubic clusters is the same as that of the α-Fe grains in the nanocrystalline alloy, and the lattice constant is similar to that of the α-Fe (for example, the lattice constant of the CuZr clusters is 0.32 nm, and the lattice constant of the pure α-Fe is 0.286 nm). Thus, in the subsequent heat treatment process of the amorphous alloy, the Cu—X clusters serve as the nucleation sites for the precipitation of the α-Fe grains in the amorphous alloy, so that the α-Fe grains are homogeneously distributed. On the other hand, these Cu—X clusters also serve as barriers and pinning points to prevent the α-Fe grains from further growth in the heat treatment process, thereby avoiding the formation of coarse grains. Therefore, the heat-treated nanocrystalline alloy has homogeneous and small grain size, and has better soft magnetic properties and higher permeability than the nanocrystalline alloy developed before.

The design of the amorphous alloy ingredients above will be further described below:

In the alloy ingredients, Fe is an essential magnetic element, and is the key to ensuring a high saturation flux density. However, a too high Fe content will reduce the amorphous forming ability of the alloy, which enables the amorphous alloy to precipitate coarse grains in the preparation process, thereby causing the degradation of the soft magnetic properties. The atomic percent of Fe determined in the invention is 74-82, preferably 75-80.

B is an element conducive to the formation of the amorphous alloy. When its content is too low, it is not easy to form a complete amorphous solid. When its content is too high, it will reduce the saturation flux density of the alloy and result in a reduction in the amorphous forming ability. The atomic percent of B is 4-10, preferably 5-9.

Si element can improve the fluidity of the alloy and increase the disorder degree of the arrangement of atoms in the alloy, thereby improving the amorphous forming ability and forming ability of the alloy and reducing the difficulty of material preparation.

The effect of adding Cu and X to the alloy at the same time at a certain ratio, as described above, is to form subnanometer-scale Cu—X ordered atom clusters homogeneously distributed in the amorphous alloy, so that the grains of the nanocrystalline alloy obtained by heat treatment are homogeneously distributed and further refined, which is the key of the invention. However, the excessive addition may easily cause the formation of coarse Cu—X grains in the amorphous alloy, which affects the soft magnetic properties. When the adding amount is too small, the clusters formed are small in number and low in density, and thus cannot play the role of refining nanocrystalline grains. The contents of Cu and X are respectively controlled to 0.5≤d≤1.2 and 0.4≤e≤1.8, and 0.8≤e/d≤1.5, preferably 0.8≤d≤1.2 and 0.64≤e≤1.5. It is creative in the invention that Cu and X are first prepared into an alloy ingot which is subsequently added to a liquid alloy. The prepared amorphous alloy ribbon contains a large number of Cu—X ordered atom clusters, so the nanocrystalline grain size is smaller and more controllable in heat treatment process, and the permeability at high frequency is higher.

Large atoms of V, Ta and Nb etc. can form strong interatomic bonding with atoms of host elements Fe, Si and B etc. Due to the difficulty of diffusion of large atoms, proper addition can improve the thermal stability of the alloy, inhibit the growth of nanocrystalline grains and improve the amorphous forming ability. The atomic percent of such elements is 1-3.5, preferably 1.5-3.

In addition, Fe in the alloy of the invention can be partially substituted by at least one element selected from Co, Ni, C, P, Ge, Cr, Mn, W, Zn, Sn, Sb and Mo, which plays a role of improving the amorphous forming ability of the alloy. Considering that the saturation flux density will decrease after Fe is substituted by such elements, the atomic percent of this substitution is controlled within 1.

(II) Preparation Method of the Amorphous Alloy

In order to prepare the above amorphous alloy containing Cu—X ordered atom clusters, a Cu—X intermediate alloy is smelted firstly according to the contents of Cu and X in the amorphous alloy, then the Cu—X intermediate alloy is added to a liquid master alloy in which the remaining ingredients are homogeneously smelted before preparing an amorphous alloy ribbon, powder or wire. After the Cu—X intermediate alloy is completely molten into the liquid master alloy, holding for a long time or at high temperature is not allowed. This is because there is a large negative enthalpy of mixing between X and host elements such as Fe, Si and B in the alloy, and atom pairs with a strong bonding force can be formed, thereby affecting the formation of the Cu—X ordered clusters.

Accordingly, the invention further provides a preparation method of the above Fe-based amorphous alloy containing subnanometer-scale ordered clusters. The preparation method includes the following steps:

(1) Proportioning: pure Cu and pure X (metals) are weighed according to a ratio of Cu to X in the composition expression of the alloy to formulate raw materials of a Cu—X intermediate alloy. Various other raw materials are weighed according to the ratio of the remaining elements (Fe, Si, B, M and M′) in the alloy composition to formulate raw materials of a Fe—Si—B-M-M′ alloy.

(2) Smelting of Fe—Si—B-M-M′ master alloy: the raw materials of the Fe—Si—B-M-M′ alloy formulated in step (1) are homogeneously smelted and deslagged, and then the smelted liquid alloy is cooled to obtain a Fe—Si—B-M-M′ master alloy ingot with homogeneous ingredients.

(3) Smelting of Cu—X intermediate alloy: the raw materials of the Cu—X intermediate alloy formulated in step (1) are smelted homogeneously and deslagged, and then the smelted Cu—X liquid intermediate alloy is cooled to obtain a Cu—X intermediate alloy ingot with homogeneous ingredients.

(4) Preparation of amorphous alloy material: proper amounts of the Fe—Si—B-M-M′ master alloy ingot prepared in step (2) and the Cu—X intermediate alloy ingot prepared in step (3) are weighed according to the contents of various elements in the composition expression of the alloy. First, the weighed master alloy ingot is re-melted on a ribbon, powder or wire preparation apparatus. After being completely molten, the master alloy is kept warm for more than 5 minutes. Then, the weighed Cu—X intermediate alloy ingot is added to the molten master alloy. After the intermediate alloy is completely molten, a material preparation apparatus is used to make the liquid alloy into an amorphous alloy ribbon, or an amorphous alloy powder or an amorphous alloy wire, thereby obtaining the Fe-based amorphous alloy containing subnanometer-scale ordered clusters.

The above raw materials of the invention are most ideally pure metals or alloys, or the purity is not less than 99 wt %.

In the invention, the amorphous alloy ribbon can be prepared from the liquid alloy by single roll melt spinning. The amorphous alloy powder can be prepared from the liquid alloy by atomization. The amorphous alloy wire can be prepared from the liquid alloy by melt drawing or other methods.

(III) Nanocrystalline Alloy Derivative

The invention further provides a nanocrystalline alloy derivative obtained after heat-treating the above Fe-based amorphous alloy containing subnanometer-scale ordered clusters. Specifically, the above Fe-based amorphous alloy containing subnanometer-scale ordered clusters is heat-treated to obtain the nanocrystalline alloy derivative with excellent soft magnetic properties. The composition expression of the nanocrystalline alloy derivative is FeₐSi_{b}B_{c}(Cu_{d}Xₑ)M_{f}M′_{g}, where X is at least one of Ti, Zr and Hf, M is at least one of V, Ta and Nb, and M′ is at least one of Co, Ni, C, P, Ge, Cr, Mn, W, Zn, Sn, Sb and Mo; where a, b, c, d, e, f and g respectively represent the atomic percent (percentage of the number of atoms) of the corresponding element, and satisfy: 74≤a≤82, 8≤b≤15, 4≤c≤10, 0.5≤d≤1.2, 0.4≤e≤1.8, 1≤f≤3.5, 0≤g≤1, 0.8≤e/d≤1.5 and a+b+c+d+e+f+g=100. The nanocrystalline alloy derivative is a composite composed of an amorphous alloy matrix and grains with a size of 5-20 nm homogeneously dispersed in the matrix.

Further, according to the nanocrystalline alloy derivative, the grains are α-Fe grains, and the size of the α-Fe grains is preferably 6-16 nm.

Further, according to the nanocrystalline alloy derivative, the nanocrystalline alloy derivative may be ribbon-like, powder-like or wire-like in shape.

Further, according to the nanocrystalline alloy derivative, a preparation method of the nanocrystalline alloy derivative includes: heat-treating the above Fe-based amorphous alloy containing subnanometer-scale ordered clusters in a heat treatment furnace under proper conditions such that the amorphous alloy precipitates nanocrystalline grains with a size of 5-20 nm around the ordered atom clusters, thereby forming the nanocrystalline alloy.

Further, according to the nanocrystalline alloy derivative, the heat treatment conditions include heating rate, holding temperature, holding time, direction and intensity of the applied magnetic field, etc.

Further, according to the nanocrystalline alloy derivative, the ribbon-like material of the nanocrystalline alloy derivative has ultrahigh permeability at high frequency: the permeability at the frequency of 100 kHz is 35000 or above, and the saturation flux density is 1.3 T or above.

The advantages and beneficial effects of the invention mainly include:

(1) The permeability at high frequency of the nanocrystalline alloy of the invention is significantly higher than that of the existing nanocrystalline alloy. By introducing the homogeneously distributed ordered atom clusters into the amorphous alloy as the nucleation sites for the precipitation of nanocrystalline grains, the nanocrystallization process of the amorphous alloy of the invention during the heat treatment is more controllable, and the grains of the prepared nanocrystalline alloy are smaller in size and more homogeneous in distribution than the grains of the commercial FINEMET alloy and other existing nanocrystalline alloys, so the permeability at high frequency is higher. The permeability at 100 kHz of the nanocrystalline alloy ribbon of the invention can reach 35000 or above, which is significantly higher than the permeability of the FINEMET alloy under the heat treatment conditions of a transverse magnetic field (the permeability of a 16 μm ultrathin ribbon is about 30000), and is also higher than a value (about 30000) of the nanocrystalline alloy disclosed by the Patent CN 108559926A.

(2) Among similar nanocrystalline alloys with high permeability, the nanocrystalline alloy of the invention has higher saturation flux density, which is more conductive to the miniaturization of electronic components. The saturation flux density of the series of nanocrystalline alloys of the invention is up to 1.3 T or above, which is higher than that of the FINEMET alloy (about 1.25 T). Besides, the Fe content in the alloy of the invention is 74% or above, preferably 75% or above, which is higher than that in the series of nanocrystalline alloys (67%-74.2%) of the Patent CN 108559926A, and therefore, the saturation flux density is also higher than that of the nanocrystalline alloys of this patent.

### BRIEF DESCRIPTIONS OF THE DRAWINGS

FIG. 1 shows a high-resolution transmission electron microscopy image and an electron diffraction pattern of an amorphous alloy ribbon of Embodiment 1 of the invention.

FIG. 2 shows an X-ray diffraction pattern of amorphous alloy ribbons of Embodiment 1, Embodiment 5 and Embodiment 8 of the invention.

FIG. 3 shows a transmission electron microscope image and an electron diffraction pattern of a nanocrystalline alloy ribbon prepared by heat-treating the amorphous alloy ribbon of Embodiment 1 of the invention.

FIG. 4 shows an X-ray diffraction pattern of nanocrystalline alloy ribbons of Embodiment 1, Embodiment 5 and Embodiment 8 of the invention.

FIG. 5 shows a pattern of the permeability of nanocrystalline alloy ribbons of Embodiments 1, 5 and 8 and Comparative Embodiments 1, 2 and 4 of the invention as a function of frequency.

FIG. 6 shows magnetic hysteresis loops of the nanocrystalline alloy ribbons of Embodiments 1, 5 and 8 and Comparative Embodiment 1 of the invention.

### DETAILED DESCRIPTIONS OF EMBODIMENTS

The invention will be further described in detail below with reference to the accompanying drawing and specific embodiments. It should be noted that the following embodiments are intended to facilitate the understanding of the invention and do not limit the invention in any way.

### Embodiment 1

In this embodiment, the composition expression of the Fe-based amorphous alloy containing subnanometer-scale ordered clusters is Fe₇₄Si₁₃B₉Nb_{2.2}Cu₁Zr_{0.8}.

The preparation and heat treatment method and steps of the Fe-based amorphous alloy were described as follows:

(1) Proportioning: Pure Cu and pure Zr (metals) with purities of not less than 99 wt % were weighed according to a ratio of Cu to Zr in the composition expression of the alloy to formulate raw materials of a Cu—Zr intermediate alloy. Pure iron, pure silicon, a boron-iron alloy and a niobium-iron alloy with purities of not less than 99 wt % were weighed according to the ratio of the remaining elements (Fe, Si, B and Nb) in the alloy composition to formulate raw materials of a Fe—Si—B—Nb alloy.

(2) Smelting of Fe—Si—B—Nb master alloy: The raw materials of the Fe—Si—B—Nb alloy formulated in step (1) were added to a crucible of a vacuum induction smelting furnace, and the vacuum induction smelting furnace was vacuumized to 1 Pa or below and heated by energization to completely melt the raw materials of the alloy. After the raw materials of the alloy were completely molten, vacuum breaking and deslagging were carried out. After the completion of the deslagging, the “vacuumizing-smelting-deslagging” process was repeated until no impurities appeared in the liquid alloy any more. Then the furnace was cooled, and the smelted liquid alloy was poured into a cooling mold and was cooled to obtain the Fe—Si—B—Nb master alloy ingot with homogeneous ingredients.

(3) Smelting of Cu—Zr intermediate alloy: the raw materials of the Cu—Zr intermediate alloy formulated in step (1) were added to a crucible of a vacuum induction smelting furnace, and the vacuum induction smelting furnace was vacuumized to 1 Pa or below and heated by energization to completely melt the raw materials of the alloy. After the raw materials of the alloy were completely molten, vacuum breaking and deslagging were carried out. After the completion of the deslagging, the “vacuumizing-smelting-deslagging” process was repeated until no impurities appeared in the liquid alloy any more. Then the furnace was cooled, and the smelted liquid Cu—Zr intermediate alloy was poured into a cooling mold and was cooled to obtain the Cu—Zr intermediate alloy ingot with homogeneous ingredients.

(4) Preparation of amorphous alloy ribbon: A proper amount of the Fe—Si—B—Nb master alloy ingot prepared in step (2) was weighed, and then a corresponding weight of the Cu—Zr intermediate alloy prepared in step (3) was weighed according to the composition expression of the alloy and the weight of the weighed master alloy. The weighed Fe—Si—B—Nb master alloy ingot was added to a crucible of a vacuum induction smelting furnace of a ribbon making machine, and the vacuum induction smelting furnace was vacuumized to 1 Pa or below and heated by energization to re-melt the master alloy ingot. After the master alloy ingot was completely molten, the liquid alloy was held for 5 min. The weighed Cu—Zr intermediate alloy ingot was added to the molten master alloy. After the intermediate alloy was completely molten, the liquid alloy was poured into a tundish of the ribbon making machine. The liquid alloy was sprayed onto the surface of a rotating copper roll with a surface linear velocity of 30 m/s by single roll melt spinning to prepare the amorphous alloy ribbon. The ribbon had a width of 55 mm and a thickness of 18 μm.

(5) Determination of thermodynamic parameters: A differential scanning calorimeter (abbreviated as “DSC”, the same hereinafter) was used to measure thermodynamic parameters of the amorphous alloy ribbon prepared in step (4) at a heating rate of 20° C./min. The crystallization temperature of the amorphous alloy ribbon was determined to determine a range of heat treatment temperature.

(6) Preparation of magnetic core: The amorphous alloy ribbon prepared in step (4) was roll-cut into narrow ribbons with a width of 10 mm. The narrow ribbon was wound by a magnetic core winder into a circular magnetic core having an inner diameter of 20 mm, an outer diameter of 30 mm and a height of 10 mm.

(7) Heat treatment: The magnetic core prepared in step (6) was put in a vacuum heat treatment furnace. The vacuum heat treatment furnace was vacuumized and heated by energization. The magnetic core was heated to 400-550° C. at a heating rate of 5° C./min, subjected to multi-stage heat treatment at 400-550° C. for 200-300 min, and then cooled to room temperature. Then, the nanocrystalline magnetic core after vacuum heat treatment was placed in a vacuum magnetic field heat treatment furnace. The heat treatment furnace was vacuumized and heated by energization to 450-500° C. at a heating rate of 5° C./min. A 0.1 T transverse magnetic field (along a ribbon width direction) was externally applied in the furnace. The nanocrystalline magnetic core was held for 120-150 min, cooled to room temperature and discharged to obtain the nanocrystalline magnetic core with homogeneously distributed nanocrystalline grains.

The amorphous alloy ribbon, and the nanocrystalline ribbon and the magnetic core obtained after heat treatment described above were tested as follows:

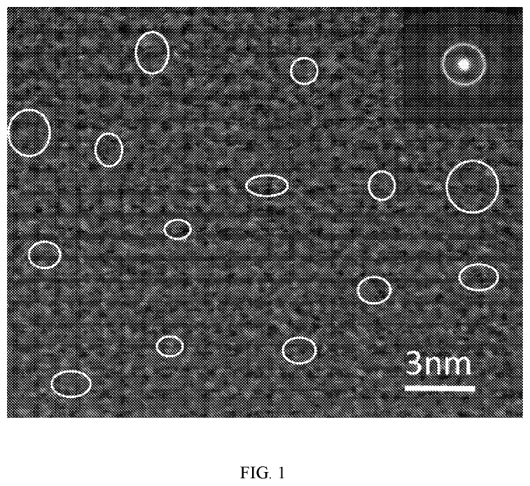

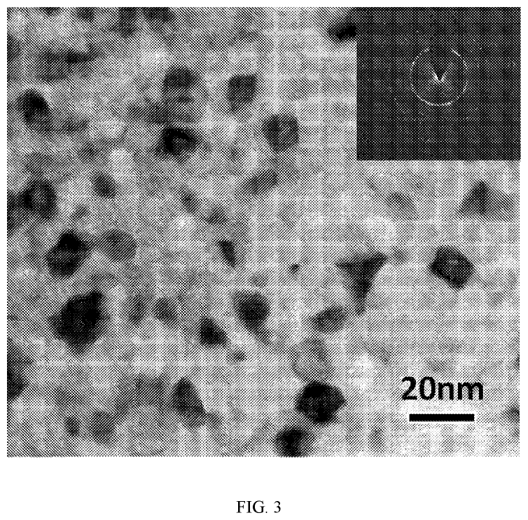

(a) A transmission electron microscope (abbreviated as “TEM”, the same hereinafter) was used to test the microstructure of the amorphous alloy ribbon prepared in step (4) and the nanocrystalline alloy ribbon prepared in step (7), as shown in FIG. 1 and FIG. 3. FIG. 1 shows a high-resolution TEM morphology image and a selected area electron diffraction pattern of the amorphous alloy ribbon. The selected area electron diffraction pattern shows a diffraction halo unique to an amorphous solid with atoms arranged disorderly. As can be seen from the TEM morphology image, ordered atom clusters with a size of 2 nm or below (shown as the white circle in the figure) are dispersed in the amorphous matrix with atoms arranged disorderly. FIG. 3 shows a TEM morphology image and a selected area electron diffraction pattern of a nanocrystalline alloy ribbon prepared after heat treatment. As can be seen from the selected area electron diffraction pattern, the halo in FIG. 1 changed to diffraction spots of a typical polycrystalline structure. As can be seen from the TEM morphology image, the nanocrystalline alloy ribbon was composed of nanocrystalline grains with a size of 20 nm or below. According to statistical analysis, the grain size was in the range of 8-16 nm.

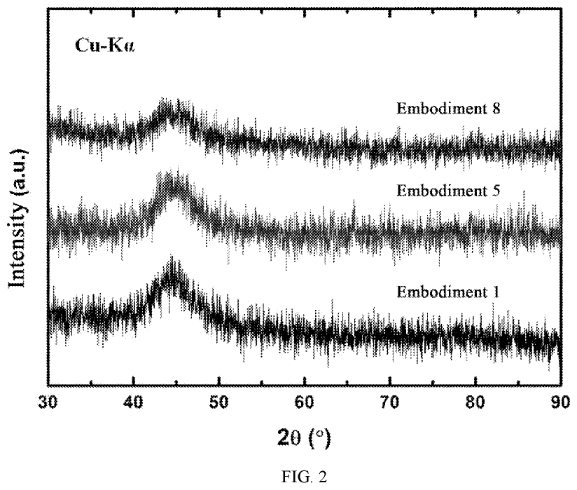

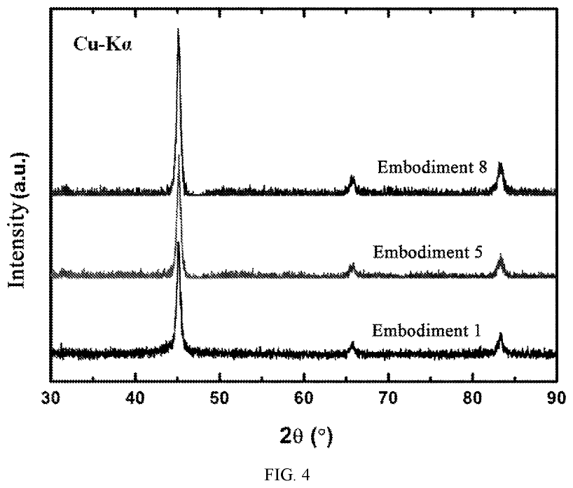

(b) A D8Advance polycrystalline X-ray diffractometer (abbreviated as “XRD”, the same hereinafter) was used to test the amorphous alloy ribbon in step (4) and the nanocrystalline alloy ribbon prepared in step (7) to obtain the XRD patterns. FIG. 2 shows the XRD pattern of the amorphous alloy ribbon. In the figure, there is only one broadened dispersion diffraction peak, and there is no obvious crystal peak, which indicates that most of the ribbon is amorphous and no crystal phase can be detected by XRD. FIG. 4 shows an XRD pattern of the nanocrystalline alloy ribbon prepared after heat treatment. In the figure, crystal peaks appear near 45°, 66° and 84°. According to analysis, a crystallization phase is a single body-centered cubic structure, that is, α-Fe.

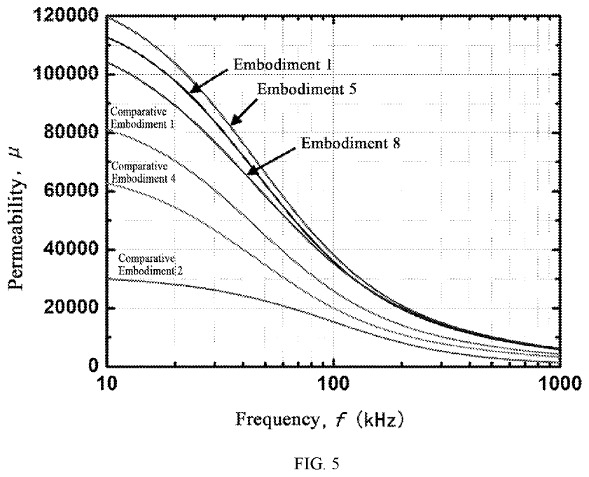

(c) An impedance analyzer was used to test the nanocrystalline magnetic core subjected to magnetic field heat treatment to obtain a pattern of permeability as a function of frequency. FIG. 5 shows typical variation curve of effective permeability, at a frequency of 10-1000 kHz, of the nanocrystalline magnetic core. The permeability, at 100 kHz, of the nanocrystalline magnetic core reached 36100, and was significantly higher than that of all comparative embodiments within the entire frequency range of 10-1000 kHz.

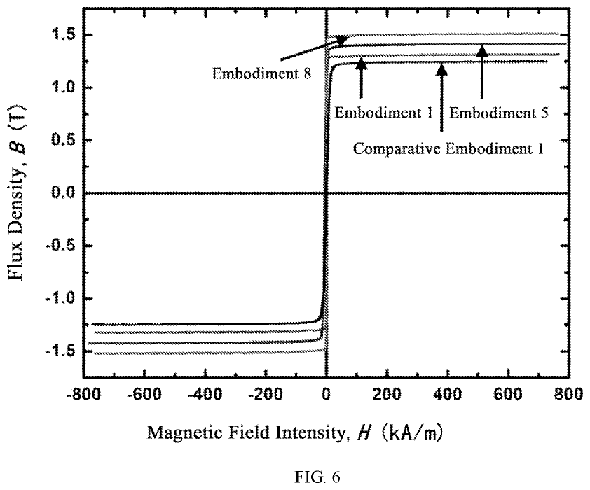

(d) A vibrating sample magnetometer (abbreviated as “VSM”, the same hereinafter) was used to measure the ribbon samples of the nanocrystalline magnetic cores prepared in step (7) above to obtain magnetic hysteresis loops, as shown in FIG. 6. The saturation flux density Bs reached 1.31 T.

The saturation flux density Bs, the effective permeability μ at 100 kHz (@100 kHz) and the internal grain size D of the nanocrystalline alloy prepared after magnetic field heat treatment in step (7) in this embodiment are listed in Table 1.

### Embodiments 2-14

The specific ingredients of each alloy, that is, the composition expression, are shown in Table 1.

The preparation and heat treatment methods and steps of the amorphous alloy ribbons of this series of embodiments were basically the same as in Embodiment 1. Except that the raw materials and proportioning thereof, the smelting temperature of the alloy, the remelting temperature, the ribbon spraying temperature and the heat treatment process parameters were different from those in Embodiment 1 due to different alloy ingredients, other methods and process parameters were the same as those in Embodiment 1. In the embodiments, an amorphous alloy ribbon with a thickness of 18 μm was prepared, and roll-cut and wound into a circular magnetic core having an inner diameter of 20 mm, an outer diameter of 30 mm and a height of 10 mm, the circular magnetic core was subjected to vacuum heat treatment and transverse magnetic field heat treatment, and a 0.1 T transverse magnetic field was applied during the magnetic field heat treatment.

The amorphous alloy ribbons, and the nanocrystalline alloy ribbons and the magnetic cores obtained after heat treatment in the embodiments were tested as in Embodiment 1, and the saturation flux density Bs, the effective permeability μ at 100 kHz (@100 kHz) and the internal grain size D are listed in Table 1. As for Embodiment 5 and Embodiment 8, the XRD pattern of the amorphous alloy ribbon is shown in FIG. 2, the XRD pattern of the nanocrystalline alloy ribbon prepared after heat treatment is shown in FIG. 4, the typical variation curve of the permeability, at the frequency of 10-1000 kHz, of the nanocrystalline magnetic core prepared after magnetic field heat treatment is shown in FIG. 5, and the magnetic hysteresis loop of the nanocrystalline ribbon is shown in FIG. 6. Other test results of the other embodiments are not shown one by one.

It can be seen from data in Table 1 that in the nanocrystalline alloys of all above embodiments, the grain size is basically within the range of 6-16 nm, the permeability at the frequency of 100 kHz reaches 35000 or above, and the saturation flux density reaches 1.3 T or above.

### Comparative Embodiment 1

The alloy in this comparative embodiment is a FINEMET nanocrystalline alloy currently industrially produced and applied, and its composition is Fe_{73.5}Si_{13.5}B₉Nb₃Cu₁.

The wide ribbon having a thickness of 18 μm and a width of 10 mm of Comparative Embodiment 1 was wound by a magnetic core winder into a circular magnetic core having an inner diameter of 20 mm, an outer diameter of 30 mm and a height of 10 mm. Then the circular magnetic core was heat-treated as follows: The magnetic core was placed in a vacuum heat treatment furnace. The vacuum heat treatment furnace was vacuumized and heated by energization. The magnetic core was heated to 380-540° C. at a heating rate of 5° C./min, subjected to multi-stage heat treatment at 380-540° C. for 300-350 min, and then cooled to room temperature. Then, the nanocrystalline magnetic core after vacuum heat treatment was placed in a vacuum magnetic field heat treatment furnace. The heat treatment furnace was vacuumized and heated by energization to 450-500° C. at a heating rate of 5° C./min. A 0.1 T transverse magnetic field (along a ribbon width direction) was externally applied in the furnace. The nanocrystalline magnetic core was held for 120-150 min, then cooled to room temperature and discharged.

The amorphous alloy ribbon, and the nanocrystalline alloy ribbon and the magnetic core obtained after heat treatment in Comparative Embodiment 1 were tested as in Embodiment 1. The high-resolution transmission electron microscopy picture of the amorphous ribbon shows that in the amorphous alloy ribbon of this comparative embodiment, the atoms are arranged completely disorderly, and there are no ordered atom clusters. The saturation flux density, the effective permeability at 100 kHz and the internal grain size of the nanocrystalline magnetic core and ribbon obtained after magnetic field heat treatment are listed in Table 1. The typical variation curve of the permeability, at 10-1000 kHz, of the nanocrystalline magnetic core is shown in FIG. 5, and the magnetic hysteresis loop of the nanocrystalline ribbon is shown in FIG. 6.

As can be seen from the comparison of data in Table 1, FIG. 5 and FIG. 6, the saturation flux density and the permeability of the nanocrystalline alloy ribbons of the embodiments of the invention are significantly higher than those of Comparative Embodiment 1, and the internal grain size of the nanocrystalline alloys of the embodiments of the invention is smaller than that of Comparative Embodiment 1, which should be the main reason why the permeability of the alloy of the invention is higher than that of Comparative Embodiment 1.

### Comparative Embodiment 2

The composition expression of the alloy of this comparative embodiment is Fe₇₆Si₁₃B₈Nb₁Cu₁Mo₁.

The preparation and heat treatment method and steps of the Fe-based amorphous alloy ribbon were as follows:

(1) Proportioning: Pure iron, pure silicon, a boron-iron alloy, a niobium-iron alloy, pure copper and pure molybdenum with purities of greater than 99 wt % were proportioned according to the composition expression of the alloy.

(2) Smelting of master alloy: The raw materials of the alloy formulated in step (1) were added to a crucible of a vacuum induction smelting furnace, and the vacuum induction smelting furnace was vacuumized to 1 Pa or below and heated by energization to completely melt the raw materials of the alloy. After the raw materials of the alloy were completely molten, vacuum breaking and deslagging were carried out. After the completion of the deslagging, the “vacuumizing-smelting-deslagging” process was repeated until no impurities appeared in the liquid alloy any more. Then the furnace was cooled, and the smelted liquid alloy was poured into a cooling mold and was cooled to obtain the master alloy ingot with homogeneous ingredients.

(3) Preparation of ribbon: A proper amount of the master alloy ingot prepared in step (2) was weighed and added to a crucible of a vacuum induction smelting furnace of a ribbon making machine, and the vacuum induction smelting furnace was vacuumized to 1 Pa or below and heated by energization to remelt the master alloy ingot. After the master alloy ingot was completely molten, the liquid alloy was held for 5 min. Then the liquid alloy was poured into a tundish of the ribbon making machine. The liquid alloy was sprayed onto the surface of a rotating copper roll with a surface linear velocity of 30 m/s by single roll melt spinning to prepare the amorphous alloy ribbon. The ribbon had a width of 25 mm and a thickness of 18 μm.

(4) Determination of thermodynamic parameters: A differential scanning calorimeter was used to measure thermodynamic parameters of the amorphous alloy ribbon prepared in step (3) at a heating rate of 20° C./min. The crystallization temperature of the amorphous alloy ribbon was determined to determine a range of heat treatment temperature.

(5) Preparation of magnetic core: The amorphous alloy ribbon prepared in step (3) was roll-cut into narrow ribbons with a width of 10 mm. The narrow ribbon was wound by a magnetic core winder into a circular magnetic core having an inner diameter of 20 mm, an outer diameter of 30 mm and a height of 10 mm.

(6) Heat treatment: The magnetic core prepared in step (5) was put in a vacuum heat treatment furnace. The vacuum heat treatment furnace was vacuumized and heated by energization. The magnetic core was heated to 450-560° C. at a heating rate of 5° C./min, subjected to multi-stage heat treatment at 450-560° C. for 200-250 min, and then cooled to room temperature. Then, the nanocrystalline magnetic core after vacuum heat treatment was placed in a vacuum magnetic field heat treatment furnace. The heat treatment furnace was vacuumized and heated by energization to 450-500° C. at a heating rate of 5° C./min. A 0.1 T transverse magnetic field (along a ribbon width direction) was externally applied in the furnace. The nanocrystalline magnetic core was held for 120-150 min, cooled to room temperature and discharged to obtain the nanocrystalline magnetic core with homogeneously distributed nanocrystalline grains.

The amorphous alloy ribbon, and the nanocrystalline alloy ribbon and the magnetic core obtained after heat treatment in Comparative Embodiment 2 were tested as in Embodiment 1. The high-resolution transmission electron microscopy picture of the amorphous ribbon shows that in the amorphous alloy ribbon of this comparative embodiment, the atoms are arranged completely disorderly, and there are no ordered atom clusters. The saturation flux density, the effective permeability at 100 kHz and the internal grain size of the nanocrystalline magnetic core and ribbon obtained after magnetic field heat treatment are listed in Table 1. The typical variation curve of the permeability, at 10-1000 kHz, of the nanocrystalline magnetic core is shown in FIG. 5.

As can be seen from the comparison of data in Table 1 and FIG. 5, compared with Comparative Embodiment 2, the internal grain size of the nanocrystalline alloys of the embodiments of the invention is smaller, and the permeability at each frequency is significantly higher than that of the alloy of Comparative Embodiment 2.

### Comparative Embodiment 3

The alloy of this comparative embodiment has the same composition expression as Embodiment 3: Fe₇₅Si₁₂B_{8.5}Nb_{2.5}Cu₁Zr₁. The difference from Embodiment 3 is that: during the preparation process of the amorphous alloy ribbon, the ribbon preparation method as described in Comparative Embodiment 2 was used instead of the use of the Cu—Zr intermediate alloy.

The preparation and heat treatment method and steps of the Fe-based amorphous alloy ribbon were described as follows:

(1) Proportioning: Pure iron, pure silicon, a boron-iron alloy, a niobium-iron alloy, pure copper and pure zirconium with purities of greater than 99 wt % were proportioned according to the composition expression of the alloy.

(2) Smelting of master alloy: The raw materials of the alloy formulated in step (1) were added to a crucible of a vacuum induction smelting furnace, and the vacuum induction smelting furnace was vacuumized to 1 Pa or below and heated by energization to completely melt the raw materials of the alloy. After the raw materials of the alloy were completely molten, vacuum breaking and deslagging were carried out. After the completion of the deslagging, the “vacuumizing-smelting-deslagging” process was repeated until no impurities appeared in the liquid alloy any more. Then the furnace was cooled, and the smelted liquid alloy was poured into a cooling mold and was cooled to obtain the master alloy ingot with homogeneous ingredients.

(3) Preparation of ribbon: A proper amount of the master alloy ingot prepared in step (2) was weighed and added to a crucible of a vacuum induction smelting furnace of a ribbon making machine, and the vacuum induction smelting furnace was vacuumized to 1 Pa or below and heated by energization to remelt the master alloy ingot. After the master alloy ingot was completely molten, the liquid alloy was held for 5 min. Then the liquid alloy was poured into a tundish of the ribbon making machine. The liquid alloy was sprayed onto the surface of a rotating copper roll with a surface linear velocity of 30 m/s by single roll melt spinning to prepare the amorphous alloy ribbon. The ribbon had a width of 55 mm and a thickness of 18 μm.

(4) Determination of thermodynamic parameters: A differential scanning calorimeter was used to measure thermodynamic parameters of the amorphous alloy ribbon prepared in step (3) at a heating rate of 20° C./min. The crystallization temperature of the amorphous alloy ribbon was determined to determine a range of heat treatment temperature.

(5) Preparation of magnetic core: The amorphous alloy ribbon prepared in step (3) was roll-cut into narrow ribbons with a width of 10 mm. The narrow ribbon was wound by a magnetic core winder into a circular magnetic core having an inner diameter of 20 mm, an outer diameter of 30 mm and a height of 10 mm.

(6) Heat treatment: The magnetic core prepared in step (5) was put in a vacuum heat treatment furnace. The vacuum heat treatment furnace was vacuumized and heated by energization. The magnetic core was heated to 420-550° C. at a heating rate of 5° C./min, subjected to multi-stage heat treatment at 420-550° C. for 200-300 min, and then cooled to room temperature. Then, the nanocrystalline magnetic core after vacuum heat treatment was placed in a vacuum magnetic field heat treatment furnace. The heat treatment furnace was vacuumized and heated by energization to 450-500° C. at a heating rate of 5° C./min. A 0.1 T transverse magnetic field (along a ribbon width direction) was externally applied in the furnace. The nanocrystalline magnetic core was held for 120-150 min, cooled to room temperature and discharged to obtain the nanocrystalline magnetic core with homogeneously distributed nanocrystalline grains.

The amorphous alloy ribbon, and the nanocrystalline alloy ribbon and the magnetic core obtained after heat treatment in Comparative Embodiment 3 were tested as in Embodiment 1. The high-resolution transmission electron microscopy picture of the amorphous alloy ribbon shows that in the amorphous alloy of this comparative embodiment, the atoms are basically arranged completely disorderly, and there are few ordered atom clusters. The saturation flux density, the effective permeability at 100 kHz and the internal grain size of the nanocrystalline magnetic core and ribbon of this comparative embodiment are listed in Table 1.

As can be seen from the table, the saturation flux density of the nanocrystalline alloy of this comparative embodiment is the same as that of Embodiment 3. However, since there are few subnanometer-scale ordered clusters in the amorphous alloy, the size of the grains precipitating from the nanocrystalline alloy is obviously larger than that of Embodiment 3, so that the permeability is also greatly lower than that of the nanocrystalline alloy of the Embodiment 3.

### Comparative Embodiment 4

The alloy of this comparative embodiment has the same composition expression as Embodiment 8: Fe₇₈Si₁₀B₈Nb₂Cu₁Zr₁. The difference from Embodiment 8 is that: during the preparation process of the amorphous alloy ribbon, the ribbon preparation method as described in Comparative Embodiment 2 and Comparative Embodiment 3 was used instead of the use of the Cu—Zr intermediate alloy.

The preparation and heat treatment steps of the amorphous alloy ribbon and the magnetic core in this comparative embodiment will not be repeated here. Except that the raw material proportioning, the smelting temperature of the master alloy, the remelting temperature, the ribbon spraying temperature and the heat treatment process parameters were different from those in Comparative Embodiment 3 due to different alloy ingredients, the other methods and process parameters were the same as those in Comparative Embodiment 3.

The amorphous alloy ribbon, and the nanocrystalline alloy ribbon and the magnetic core obtained after heat treatment in Comparative Embodiment 4 were tested as in Embodiment 1. The high-resolution transmission electron microscopy picture of the amorphous alloy ribbon shows that in the amorphous alloy of this comparative embodiment, the atoms are basically arranged completely disorderly, and there are few ordered atom clusters. The saturation flux density, the effective permeability at 100 kHz and the internal grain size of the nanocrystalline magnetic core and ribbon of this comparative embodiment are listed in Table 1. The typical variation curve of the permeability, at 10-1000 kHz, of the nanocrystalline magnetic core is shown in FIG. 5.

As can be seen from data in Table 1 and FIG. 5, this comparative embodiment is similar to Comparative Embodiment 3: The saturation flux density of the nanocrystalline alloy is the same as that of Embodiment 8. However, since there are few subnanometer-scale ordered clusters in the amorphous alloy, the size of the nanocrystalline grains precipitating from the nanocrystalline alloy is obviously larger than that of Embodiment 8, so that the permeability is also greatly lower than that of the nanocrystalline alloy of the Embodiment 8.

TABLE 1
Summary of alloy composition, main soft magnetic properties and grain size
distribution of embodiments and comparative embodiment of the invention

| | Alloy Ingredients (at %) | Bs(T) | μ(@100 kHz) | D(nm) |
|---|---|---|---|---|
| Embodiment 1 | Fe₇₄Si₁₃B₉Nb_{2.2}Cu₁Zr_{0.8} | 1.31 | 36100 | 8-16 |
| Embodiment 2 | Fe_{74.5}Si_{12.5}B_{8.8}Nb₂Cu_{1.2}Zr₁ | 1.32 | 38500 | 9-15 |
| Embodiment 3 | Fe₇₅Si₁₂B_{8.5}Nb_{2.5}Cu₁Zr₁ | 1.35 | 35400 | 10-15 |
| Embodiment 4 | Fe_{75.5}Si_{12.5}B₈ Nb₂Cu₁Hf₁ | 1.38 | 37000 | 9-14 |
| Embodiment 5 | Fe₇₆Si_{12.2}B₈Nb₂Cu₁Zr_{0.8} | 1.41 | 38300 | 6-13 |
| Embodiment 6 | Fe_{76.5}Si_{11.8}B₈Nb₂Cu_{0.9}Ti_{0.8} | 1.41 | 36000 | 8-16 |
| Embodiment 7 | Fe₇₇Si_{10.5}B₈Nb_{2.5}Cu₁Zr₁ | 1.45 | 37600 | 9-15 |
| Embodiment 8 | Fe₇₈Si₁₀B₈Nb₂Cu₁Zr₁ | 1.51 | 35700 | 7-16 |
| Embodiment 9 | Fe₇₉Si₁₀B₇Nb_{2.3}Cu_{0.8}Ti_{0.9} | 1.56 | 35000 | 6-16 |
| Embodiment 10 | Fe₈₀Si₉B_{7.2}Nb₂ Cu₁Ti_{0.8} | 1.60 | 35200 | 8-17 |
| Embodiment 11 | Fe_{79.5}Si₉B_{7.2}Nb₂Cu₁Ti_{0.8}C_{0.5} | 1.58 | 36600 | 8-16 |
| Embodiment 12 | Fe₈₀Si₉B₇Nb_{1.8}Cu_{0.9}Ti₁Co_{0.3} | 1.62 | 35100 | 7-15 |
| Embodiment 13 | Fe₇₆Si₁₂B_{7.5}Nb₂Cu₁Hf_{1.1}Cr_{0.4} | 1.40 | 37400 | 9-16 |
| Embodiment 14 | Fe₇₇Si₁₀B_{7.5}Nb₂Cu_{1.2}Zr_{1.3}P₁ | 1.45 | 36500 | 9-16 |
| Comparative | Fe_{73.5}Si_{13.5}B₉Nb₃Cu₁ | 1.25 | 26000 | 10-20 |
| Embodiment 1 | | | | |
| Comparative | Fe₇₆Si₁₃B₈Nb₁Cu₁Mo₁ | 1.39 | 15200 | 14-25 |
| Embodiment 2 | | | | |
| Comparative | Fe₇₅Si₁₂B_{8.5}Nb_{2.5}Cu₁ Zr₁ | 1.35 | 24300 | 15-25 |
| Embodiment 3 | (no intermediate alloy used) | | | |
| Comparative | Fe₇₈Si₁₀B₈Nb₂Cu₁ Zr₁ | 1.51 | 20100 | 14-22 |
| Embodiment 4 | (no intermediate alloy used) | | | |

Through the comparison of the amorphous alloys and nanocrystalline alloy derivatives in the embodiments and the comparative embodiments of the invention in the aspects of microstructure and main soft magnetic properties, it can be seen that the Fe-based amorphous alloy containing subnanometer-scale ordered clusters and the preparation method thereof provided by the invention provide an effective method for preparing a nanocrystalline alloy with high saturation flux density and high permeability: Through the design of the alloy ingredients and the amorphous alloy preparation method matched therewith, the Fe-based amorphous alloy containing a large number of subnanometer-scale ordered atom clusters is prepared, and thereby can precipitate more homogeneous and smaller nanocrystalline grains during the subsequent heat treatment process, so that the soft magnetic properties of the nanocrystalline alloy are greatly improved and the high-frequency permeability is significantly increased (the permeability at 100 kHz is up to 35000 or above). At the same time, since the Fe content in the alloy is higher than that in the commercial FINEMET alloy, a higher saturation flux density is also obtained, reaching 1.3 T or above.

The above embodiments systematically describe the technical solutions of the invention in detail, but it should not be considered that the specific implementation of the invention is limited to these descriptions. A person of ordinary skill in the technical field to which the invention belongs can also make some simple deductions or substitutions without departing from the concept of the invention, all of which should be regarded as falling within the protection scope of the invention.

1. A Fe-based amorphous alloy containing subnanometer-scale ordered clusters, wherein the composition expression of the Fe-based amorphous alloy is FeₐSi_{b}B_{c}(Cu_{d}Xₑ)M_{f}M′_{g}, and Xis at least one of Ti, Zr and Hf, M is at least one of V, Ta and Nb, and M′ at least one of Co, Ni, C, P, Ge, Cr, Mn, W, Zn, Sn, Sb and Mo; a, b, c, d, e, f and g respectively represent the atomic percent (percentage of the number of atoms) of the corresponding element, and satisfy: 74≤a≤82, 8≤b≤15, 4≤c≤10, 0.5≤d≤1.2, 0.4≤e≤1.8, 1≤f≤3.5, 0≤g≤1, 0.8≤e/d≤1.5 and a+b+c+d+e+f+g=100; the Fe-based amorphous alloy is a composite material composed of an amorphous alloy matrix with atoms arranged in complete disorder and ordered atomic clusters having the size ranging from 0.5 nm to 2 nm uniformly dispersed and distributed in the matrix.

2. The Fe-based amorphous alloy containing subnanometer-scale ordered clusters of claim 1, wherein the ordered atom clusters in the Fe-based amorphous alloy are Cu—X body-centered cubic clusters formed by Cu atoms and X atoms.

3. The Fe-based amorphous alloy containing subnanometer-scale ordered clusters of claim 1, wherein the Fe-based amorphous alloy can be ribbon-like, powder-like or wire-like in shape.

4. A preparation method of the Fe-based amorphous alloy containing subnanometer-scale ordered clusters of claim 1, wherein the preparation method includes the following steps:
(1) Proportioning: pure Cu and pure X are weighed according to a ratio of Cu to X in the composition expression of the alloy to formulate raw materials of a Cu—X intermediate alloy; other raw materials including Fe, Si, B, M and M′ are weighed according to the ratio of the remaining elements in the alloy composition to formulate raw materials of a Fe—Si—B-M-M′ alloy.
(2) Smelting of Fe—Si—B-M-M′ master alloy: the raw materials of the Fe—Si—B-M-M′ alloy formulated in step (1) are homogeneously smelted and deslagged, and then the smelted liquid alloy is cooled to obtain a Fe—Si—B-M-M′ master alloy ingot with homogeneous ingredients.
(3) Smelting of Cu—X intermediate alloy: the raw materials of the Cu—X intermediate alloy formulated in step (1) are smelted homogeneously and deslagged, and then the smelted Cu—X liquid intermediate alloy is cooled to obtain a Cu—X intermediate alloy ingot with homogeneous ingredients.
(4) Preparation of amorphous alloy material: get proper amounts of the Fe—Si—B-M-M′ master alloy ingot prepared in step (2) and the Cu—X intermediate alloy ingot prepared in step (3) are weighed according to the contents of various elements in the composition expression of the alloy; re-melt the weighed master alloy ingot on a ribbon, powder or wire preparation apparatus; keep the master alloy warm for more than 5 minutes after completely molten; add the weighed Cu—X intermediate alloy ingot to the molten master alloy; after the intermediate alloy is completely molten, a material preparation apparatus is used to make the liquid alloy into an amorphous alloy ribbon, or an amorphous alloy powder or an amorphous alloy wire, obtaining the Fe-based amorphous alloy containing subnanometer-scale ordered clusters.

5. A nanocrystalline alloy derivative of the Fe-based amorphous alloy containing subnanometer-scale ordered clusters of claim 1, wherein the composition expression of the nanocrystalline alloy derivative is FeₐSi_{b}B_{c}(Cu_{d}Xₑ)M_{f}M′_{g}, and X is at least one of Ti, Zr and Hf, M is at least one of V, Ta and Nb, and M′ at least one of Co, Ni, C, P, Ge, Cr, Mn, W, Zn, Sn, Sb and Mo; where a, b, c, d, e, f and g respectively represent the atomic percent (percentage of the number of atoms) of the corresponding element, and satisfy: 74≤a≤82, 8≤b≤15, 4≤c≤10, 0.5≤d≤1.2, 0.4≤e≤1.8, 1≤f≤3.5, 0≤g≤1, 0.8≤e/d≤1.5 and a+b+c+d+e+f+g=100; the nanocrystalline alloy derivative is a composite composed of an amorphous alloy matrix and grains with a size of 5-20 nm homogeneously dispersed in the matrix.

6. The nanocrystalline alloy derivative of claim 5, wherein the grains are α-Fe grains, and the size of the α-Fe grains is 6-16 nm.

7. The nanocrystalline alloy derivative of claim 5, wherein the nanocrystalline alloy derivative is ribbon-like, powder-like or wire-like in shape.

8. The nanocrystalline alloy derivative of claim 5, wherein the preparation method of the nanocrystalline alloy derivative includes: heat-treating the Fe-based amorphous alloy containing subnanometer-scale ordered clusters in a heat treatment furnace under proper conditions such that the amorphous alloy precipitates nanocrystalline grains with a size of 5-20 nm around the ordered atom clusters to form the nanocrystalline alloy.

9. The nanocrystalline alloy derivative of claim 8, wherein the heat treatment conditions include heating rate, holding temperature, holding time, direction and intensity of the applied magnetic field.

10. The nanocrystalline alloy derivative of claim 5, wherein the ribbon-like material of the nanocrystalline alloy derivative has ultrahigh permeability: the permeability at the frequency of 100 kHz is more than 35000, and the saturation flux density more than 1.3 T.
